(19) United States
(12) Patent Application Publication
(10) Pub. No.: US 2013/0135362 A1
(43) Pub. Date: May 30, 2013

(54) DATA DRIVER DRIVING METHOD FOR REDUCING GAMMA SETTLING TIME AND DISPLAY DRIVE DEVICE

(71) Applicants: Jong-Hyun KIM, Seoul (KR); Jeehwal KIM, Seoul (KR); Sungho YUO, Namdong-gu (KR)

(72) Inventors: Jong-Hyun KIM, Seoul (KR); Jeehwal KIM, Seoul (KR); Sungho YUO, Namdong-gu (KR)

(21) Appl. No.: 13/569,398

(22) Filed: Aug. 8, 2012

(30) Foreign Application Priority Data
Nov. 24, 2011 (KR) 10-2011-0123534

(51) Int. Cl. G09G 5/10

(52) U.S. Cl. 345/690

(57) ABSTRACT

A data driver driving method includes separately generating gamma voltages through respective separate gamma voltage generators according to colors, applying the separate gamma voltages to their corresponding drive circuits in a data driver through separate channels to obtain first, second, and third color converting outputs, and alternately and sequentially applying the first, second, and third color converting outputs to common pixel nodes of a panel.

### CROSS-REFERENCE TO RELATED APPLICATIONS

This US non-provisional patent application claims priority under 35 USC §119 to Korean Patent Application No. 10-2011-0123534, filed on Nov. 24, 2011, the entirety of which is hereby incorporated by reference.

### BACKGROUND

1. Field

The present general inventive concept relates to display devices and, more particularly, to a data driver driving method capable of reducing or minimizing gamma settling time and a display drive device.

2. Description of the Related Art

Panels widely used in mobile electronic devices tend to be larger in size according to users' requirements. In the larger panels, however, the speed issue of a display drive device, e.g., a display drive integrated circuit (IC), is emerging in recent years.

### SUMMARY

Embodiments of the inventive concept provide a data driver driving method and a display drive device.

In an aspect of the inventive concept, a data driver driving method may include separately generating gamma voltages through respective separate gamma voltage generators according to colors, applying the separate gamma voltages to their corresponding drive circuits in a data driver through separate channels to obtain first, second, and third color converting outputs, and alternately and sequentially applying the first, second, and third color converting outputs to common pixel nodes of a panel.

Generating the gamma voltages may include generating an R gamma voltage, a G gamma voltage, and a B gamma voltage having different voltage levels.

Applying the separate gamma voltages to their corresponding drive circuits may include applying the R gamma voltage, the G gamma voltage, and the B gamma voltage to respective first, second, and third decoders, and obtaining the first, second, and third color converting outputs includes obtaining outputs of respective first, second, and third amplifiers connected to respective output terminals of the first, second, and third decoders.

The first, second, and third color converting outputs may be output simultaneously at the outputs of the respective first, second, and third amplifiers.

Applying the generated voltages through separate channels may include using an R channel, a G channel, and a B channel in a one-amplifier one-pixel structure.

The panel may be an organic light emitting diode (OLED) panel.

Alternately and sequentially applying the color converting outputs may include applying the first, second, and third color converting outputs alternately in orders of first-second-third color converting outputs, second-third-first color converting outputs, and third-first-second color converting outputs when they are applied to adjacent first, second, and third common pixel nodes among the common pixel nodes.

Alternately and sequentially applying the color converting outputs may include varying a color arrangement order of a unit pixel switch connected to the common pixel node in accordance with pixel locations in the panel.

Varying the color arrangement may include disposing the unit pixel switch in an order of R, G, B, G, B, R, B, R, and G colors when first, second, and third pixels are disposed in the panel.

Varying the color arrangement may include repeating the color arrangement order of the unit pixel switch in units of three pixels.

In an aspect of the inventive concept, a display drive device may include first, second, and third gamma voltage generators configured to generate gamma voltages according to R, G, and B colors, a drive circuit configured to receive the gamma voltages generated according to the R, G, and B colors through three channels, and to generate first, second, and third color converting outputs by adding the received gamma voltages to a pixel signal according to the channels, and a switching unit configured to alternately and sequentially apply the first, second, and third color converting outputs to common pixel nodes of a panel.

The three channels may be an R channel, a G channel, and a B channel in a one-amplifier one-pixel structure.

The drive circuit may include first, second, and third decoders configured to receive the R gamma voltage, the G gamma voltage, and the B gamma voltage, respectively, and first, second, and third amplifiers connected to output terminals of the first, second, and third decoders, respectively.

The panel may be a liquid crystal panel or an active organic light emitting diode panel.

A color arrangement order of a unit pixel switch connected to the common pixel node may vary in accordance with pixel locations in a panel.

The unit pixel switch may be repeatedly disposed in every three pixels in the order of R, G, B, G, B, R, B, R, and G colors.

In an aspect of the inventive concept, a display drive device may include a plurality of separate gamma voltage generators configured to generate respective separate gamma voltages according to colors, a drive circuit configured to receive the separate gamma voltages and to generate respective color converting outputs, and a switching unit configured to alternately and sequentially apply the color converting outputs to common pixel nodes of a panel.

The display drive device may further include a plurality of separate channels connected to the gamma voltage generators, respectively, the separate gamma voltages being transmitted to the drive circuit independently of each other.

The display drive device may include three separate gamma voltage generators, the gamma voltage generators being configured to generate gamma voltage according to R, G, or B colors, respectively.

The drive circuit may be configured to output the respective color converting outputs simultaneously.

### BRIEF DESCRIPTION OF THE DRAWINGS

Features will become apparent to those of ordinary skill in the art by describing in detail exemplary embodiments with reference to the attached drawings, in which:

FIG. 1 illustrates a schematic block diagram of a display device according to an embodiment of the inventive concept.

FIG. 2 illustrates a block diagram of a data driver in FIG. 1.

FIG. 3 illustrates a connection between a portion of a data driver in FIG. 2 and a gamma voltage generator in FIG. 1.

FIG. 4 illustrates a detailed connection configuration diagram of a drive circuit and a switching unit in FIG. 3.

FIG. 5 illustrates an exemplary diagram of an increase of gamma settling time when a single gamma voltage generator is used.

FIG. 6 illustrates an exemplary circuit diagram of the gamma voltage generator in FIG. 3.

FIG. 7 illustrates another exemplary circuit diagram of the gamma voltage generator in FIG. 3.

FIG. 8 illustrates an exemplary implementation diagram of a decoder in FIG. 4.

FIG. 9 illustrates a block diagram of a mobile electronic device employing a display drive IC (DDI) according to the inventive concept.

FIG. 10 illustrates a block diagram of an application example applied to various display devices.

### DETAILED DESCRIPTION

The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose examples of the inventive concept and to let those skilled in the art understand the nature of the inventive concept.

In the specification, it will also be understood that when an element (or line) is referred to as being “on” another element or a target element block, it can be directly on the other element, or intervening elements may also be present. In addition, it will also be understood that when an element is referred to as being “between” two elements, it can be the only element between the two elements, or one or more intervening elements may also be present. In the drawing figures, dimensions of elements and regions may be exaggerated for clarity of illustration. Like reference numerals refer to like elements throughout.

The terms used in the specification are for the purpose of describing particular embodiments only and are not intended to be limiting of the invention. As used in the specification, the singular forms “a”, “an” and “the” are intended to include the plural forms as well, unless the context clearly indicates otherwise. It will be further understood that the terms “comprises” and/or “comprising”, when used in the specification, specify the presence of stated features, integers, steps, operations, elements, and/or components, but do not preclude the presence or addition of one or more other features, integers, steps, operations, elements, components, and/or groups thereof.

Each embodiment described and exemplified herein may include a complementary embodiment thereof. Note that display devices such as organic light emitting diode (OLED), liquid crystal display (LCD), and plasma display panel (PDP) and their detailed basic operations will not be described to avoid ambiguity of the feature of the inventive concept.

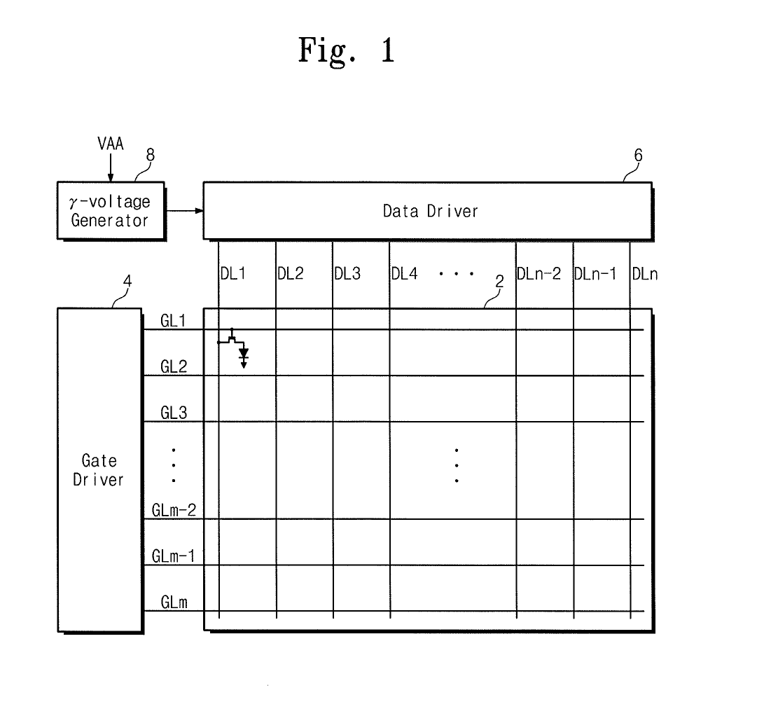

FIG. 1 is a schematic block diagram of a display device according to an embodiment of the inventive concept. As illustrated in FIG. 1, the display device may include a panel 2, a gate driver 4, a data driver 6, and a gamma voltage generator 8, i.e., a γ-voltage generator 8.

The panel 2 may be, e.g., a light-receiving panel that operates when there is external light or a light-emitting panel that self-emits light. For example, thin film transistor light liquid crystal displays (TFT-LCDs), which are most widely used in flat panel display (FPD) technologies, are representative light-receiving display products. In another example, light emitting diodes (LEDs), which are mainly used in cell phones or electronic display boards, are representative light-emitting display products. An organic LED (OLED) is formed of three kinds of self-luminous fluorescent organic compounds of red (R), green (G), and blue (B). The OLED uses a phenomenon where electrons and positively-charged particles introduced from a cathode and an anode bond in an organic material to self-emit light. For this reason, the OLED does not require a backlight unit (BLU) that causes color vision of a panel to be degraded. OLED panels may be categorized into two types, i.e., a passive matrix (PM) type in which pixels are simply crossed at an anode and a cathode and an active matrix (AM) type in which a thin film transistor (TFT) for switching is disposed in each pixel. If the panel 2 is a liquid crystal panel or an AM-type OLED panel, it includes thin film transistors (TFTs) disposed at cells arranged in a matrix and intersections of m gate lines GL1-GLm and n data lines DL1-DLn to switch a data signal supplied to the cells.

The gate driver 4 sequentially supplies a gate signal to the gate lines GL1-GLm to drive thin film transistors connected to a corresponding gate line.

The gamma voltage generator 8 generates an R gamma voltage, a G gamma voltage, and a B gamma voltage that have different voltage levels. In a display device, gradations of R, G, and B images are changed not linearly but non-linearly according to voltage levels of image signals. This gamma characteristic causes image quality to be degraded. Intervals between the voltage levels of the image signals are made different using gamma correction voltages to prevent the degradation of the image quality. That is, the display device corrects the gamma characteristic to have voltage levels which are different according to the voltage levels of the image signals. This is accomplished by adding a predetermined gamma voltage to a voltage level of an image signal as an offset voltage.

The data driver 6 supplies a pixel signal of a 1-horizontal line to the data lines DL1-DLn. In this case, the gamma voltage generator 8 supplies a predetermined DC voltage, i.e., gamma voltage, to the data driver 6 to have voltage levels which are different according to the voltage levels of the image signals. Accordingly, the data driver 6 supplies the gamma voltage to data lines after adding the gamma voltage to a pixel signal to correct the gamma characteristic.

The data driver 6 is an integrated circuit element included in a display drive IC (hereinafter referred to as “DDI”). A high-speed operation of the DDI is significantly dependent on settling times of the R, G, and B gamma voltages. If the panel 2 is an OLED panel, the number of channels of the DDI increases with the demand for high resolution.

In a conventional DDI, R, G, and B gamma voltages are generated through a single gamma voltage generator, so R, G, and B outputs are obtained through a single channel in a time sharing manner. Therefore, an operation speed of the conventional DDI may be reduced as a number of channels increases. That is, as the number of channels increases when a size of a panel increases, gamma routing resistance increases to slow swing, e.g., fluctuation, of the gamma voltage, thereby increasing gamma settling time and reducing driving speed of the DDI.

For example, when the number of channels is 1000 or more, resistance RG of a gamma voltage generator is 150K, parasitic resistance R of a channel line is 3, and capacitance C of a channel is 80 fF, RC delay time is (150K+3*1000)*(80 f*1000). Accordingly, the RC delay time is at least 12 seconds. As such, the RC delay time has a gamma settling time of at least four, e.g., the RC delay time is at least four times larger than a required specification time of two to three seconds. The effect of the gamma settling time causes a slew viewed from a panel to be slow, irrespective of channel slew, when a voltage turns from an R gamma voltage to a G gamma voltage or from the R gamma voltage to a B gamma voltage. In contrast, a DDI according to example embodiments overcomes this problem, so high speed driving of the DDI may be achieved.

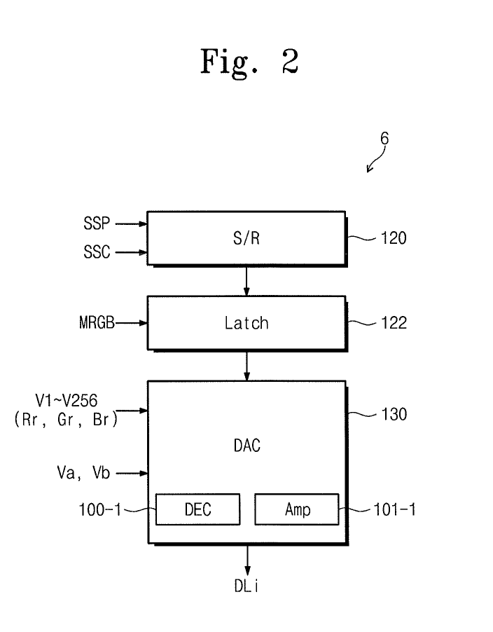

FIG. 2 is a block diagram of the data driver 6 in FIG. 1. As illustrated in FIG. 2, the data driver 6 may include a shift register (S/R) 120 configured to generate a sampling signal, a latch 122 configured to latch modulation data MRGB after sampling the MRGB according to the sampling signal of the shift register (S/R) 120, and a digital-to-analog converter (DAC) 130 configured to convert the latched modulation data MRGB into an image signal corresponding to a gamma voltage before supplying the image signal to a data line DLi.

The shift register 120 shifts a source start pulse SSP of a data control signal applied from a block, e.g., from a timing controller, according to a source shift clock SSC to generate a sampling signal.

The latch 122 samples the modulation data MRGB according to the sampling signal from the shift register 120 and latches and outputs the sampled modulation data MRGB at each 1-horizontal line.

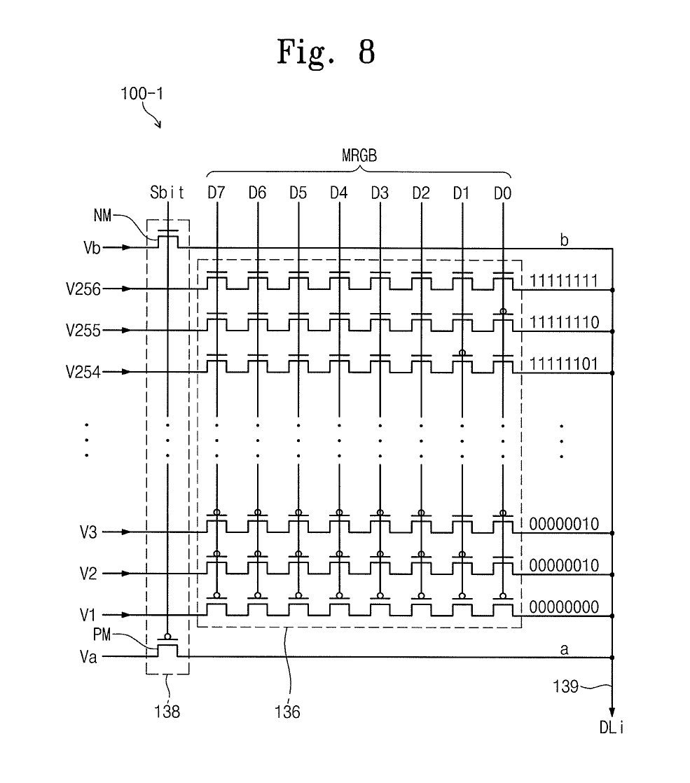

The DAC 130 selects one of gamma voltages V1-V256 applied from the gamma voltage generator 8 according to the modulation data MRGB output from the latch 122, and supplies the selected gamma voltage to the data line DLi. For achieving this, the DAC 130 includes a decoder (DEC) 100-1 and a source amplifier (Amp) 101-1. In addition, the DAC 130 may select one of first and second voltages Va and Vb according to a sine bit Sbit and supply the selected voltage Va or Vb to the data line DLi (FIG. 8).

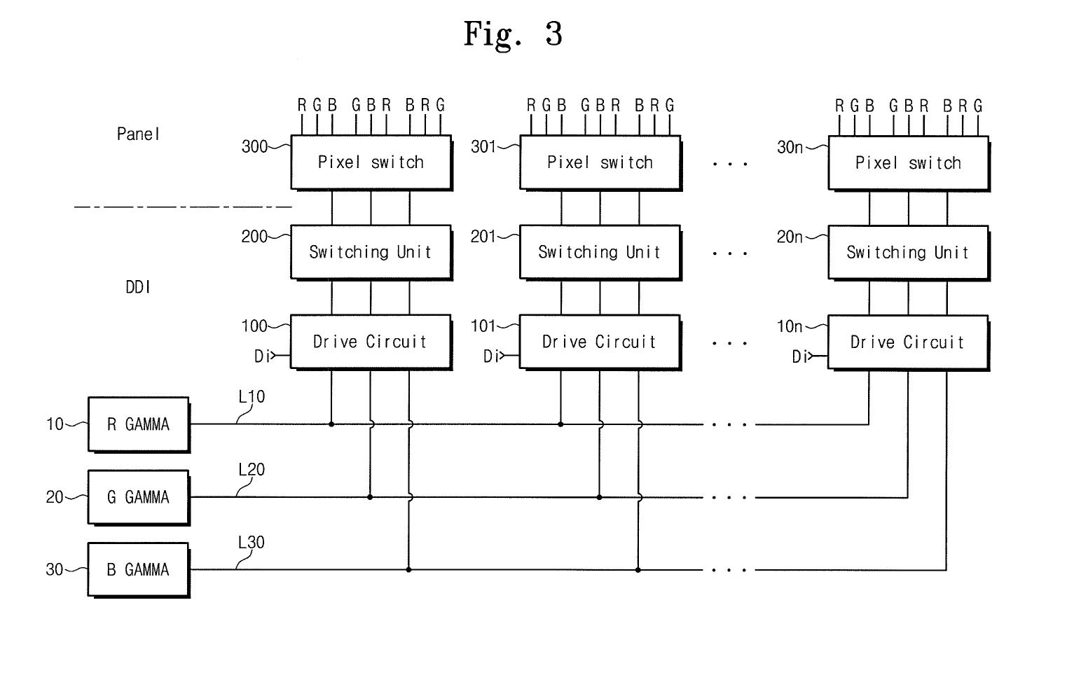

In this embodiment, the gamma voltage generator 8 (FIG. 1) may include three separate, e.g., and independent of each other, sub-generators, that are separated depending on R, G, and B to improve driving speed of the DDI, as illustrated in FIG. 3. That is, R, G, and B gamma voltages may be independently generated through three separate gamma voltage generators, respectively, to decrease gamma settling time.

In detail, as illustrated in FIG. 3, the DDI according to example embodiments may include first to third gamma voltage generators 10, 20, and 30, a plurality of drive circuits 100, 101, and 10n, and a plurality of switching units 200, 201, and 20n.

The first to third gamma voltage generators 10, 20, and 30 generate gamma voltages depending on colors of R, G, and B, respectively. For example, the first gamma voltage generator 10 generates an R gamma voltage, the second gamma voltage 20 generates a G gamma voltage, and the third gamma voltage generator 30 generates a B gamma voltage.

The drive circuits 100, 101, and 10n may differentially receive the R, G, and B gamma voltages through three channels, respectively. For example, as illustrated in FIG. 3, the drive circuit 100 may receive three separate gamma voltages corresponding to R, G, and B gamma voltages through three separate lines. The drive circuits 100, 101, and 10n add the received R, G, and B gamma voltages to pixel signals (modulation data) applied through data input terminals Di depending on the respective channels to generate first, second, and third color converting outputs.

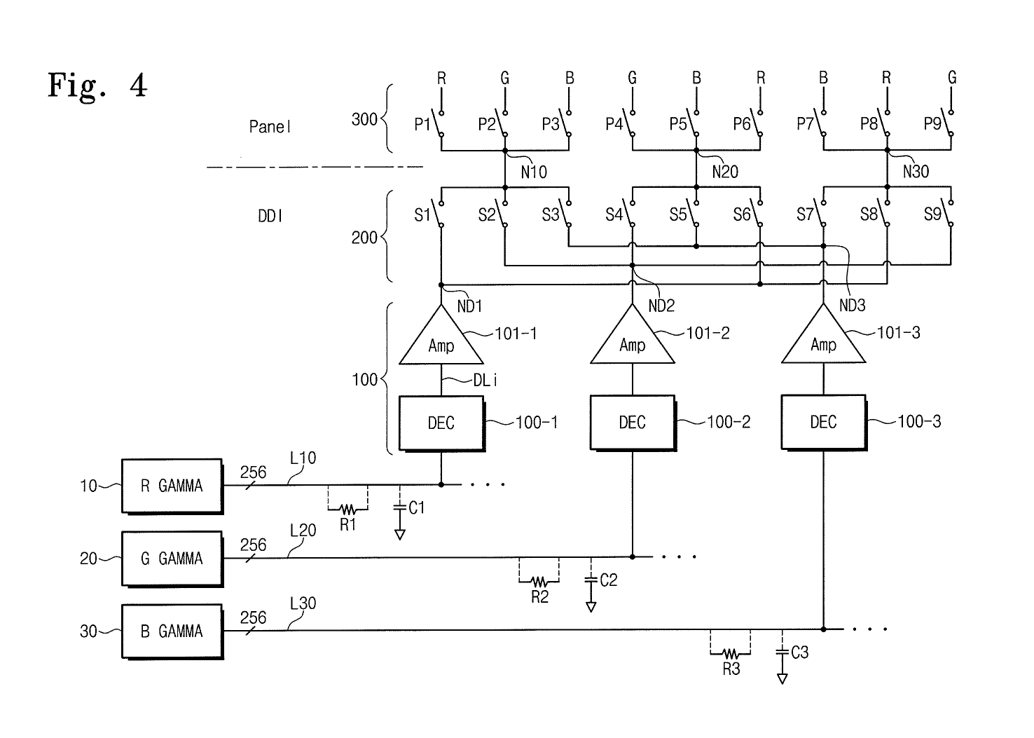

The switching units 200, 201, and 20n alternately and sequentially apply the first, second, and third color converting outputs to common pixel nodes of a panel. The common pixel nodes exist in pixel switches 300, 301, and 30n of the panel, respectively, as will be described in ore detail bellow with reference to FIG. 4.

Accordingly, by the switching operation of the switching units 200, 201, and 20n, an R gamma voltage supply line L10 may be connected to one-third channels among all the channels, a G gamma voltage supply line L20 may be connected to other one-third channels, and a B gamma voltage supply line L30 may be connected to the other one-third channels. In other words, each of the supply lines L10 through L30 may be connected to a completely different one third of the channels, such that each channel may be connected to only one supply line. A detailed connection configuration of the gamma voltage generators to the drive circuits and switching units will be described in more detail below with reference to FIG. 4.

As illustrated in FIG. 4, first to third gamma voltage generators 10, 20, and 30, a drive circuit 100, and a switching unit 200 are provided. The first to third gamma voltage generators 10, 20, and 30 generate gamma voltages corresponding to R, G, and B colors, respectively. The first to third gamma voltage generators 10, 20, and 30 may be connected through three separate lines L10 through L30 to each of the drive circuits, e.g., to the drive circuit 100. The drive circuit 100 differentially receives the gamma voltages corresponding to the R, G, and B colors through the three separate lines and generates first to third converting outputs after adding the received gamma voltages to a pixel signal. The switching unit 200 alternately and sequentially applies the first to third color converting outputs from the drive circuit 100 to the common pixel nodes N10, N20, and N30 of the panel.

The three separate lines, i.e., three separate channels, include an R channel, a G channel, and a B channel in a one-amplifier one-pixel structure. The one-amplifier one-pixel structure means a structure in which R, G, and B outputs constituting one pixel are sequentially output at an output of one amplifier (e.g., 101-1).

In case of an embodiment of the inventive concept shown in FIG. 4, three color converting outputs are simultaneously output at three respective amplifiers 101-1, 101-2, and 101-3 to reduce gamma settling time. That is, a first color converting output appears at an output node ND1 of the first amplifier 101-1, a second color converting output appears at an output node ND2 of the second amplifier 101-2, and a third color converting output appears at an output node ND3 of the third amplifier 101-3. As a result, the three amplifiers 101-1, 101-2, and 101-3 are included in a color drive circuit for each color as amplifiers for colors.

When first, fourth, and seventh switches S1, S4, and S7 in the switching unit 200 are simultaneously closed, the first, second, and third converting outputs are applied to the common pixel nodes N10, N20, and N30 of the panel, respectively. At this point, first, fourth, and seventh unit pixel switches P1, P4, and P7 in the pixel switch 300 of the panel are simultaneously closed to simultaneously supply R, G, and B outputs from the common pixel nodes N10, N20, and N30 of the panel to the respective individual pixels. For example, the G output at the common pixel node N10 is supplied, when the B output at the common pixel node N20 and the R output at the common pixel node N30 are supplied after the R, G, and B outputs are blocked.

In the structure in FIG. 4, one of the first to third color converting outputs is output at any one amplifier. However, the switching operation of the switching unit 200 allows the structure in FIG. 4 to be identical to a one-amplifier one-pixel structure.

The drive circuit 100 includes first, second, and third decoders 100-1, 100-2, and 100-3 configured to receive the respective R gamma voltage, the G gamma voltage, and the B gamma voltage from the respective first through third gamma voltage generators 10, 20, and 30. Further, first, second, and third amplifiers 101-1, 101-2, and 101-3 are connected to output terminals of the first, second, and third decoders 100-1, 100-2, and 100-3, respectively.

A color arranging order of pixel switches P1, P2, P3, . . . , and P9 connected to the common pixel nodes N10, N20, and N30 of the panel varies with corresponding pixel locations in a panel. For example, as illustrated in FIG. 4, the unit pixel switches P1-P9 are repeatedly arranged in three pixels in the color order of R, G, B, G, B, R, B, R, and G.

In detail, the unit pixel switches P1, P2, and P3 connected to the common pixel node N10 are provided to display one pixel. When the unit pixel switch Pb is closed, a first switch S1 in the switching unit 200 is closed and the R color converting output is output from the first amplifier 101-1. At the same time, the unit pixel switches P4 and P7 and fourth and seventh switches S4 and S7 are closed to output the G and B color converting outputs from the second and third amplifiers 101-2 and 101-3.

In addition, when the unit pixel switch P2 is closed, a second switch S2 in the switching unit 200 is closed and the G color converting output is output from the second amplifier 101-2. At the same time, the unit pixel switches P5 and P8 and fifth and eighth switches S5 and S8 are closed to output the B and R color converting outputs from the third and first amplifiers 101-3 and 101-1.

Similarly, when the unit pixel switch P3 is closed, the first switch S3 in the switching unit 200 is closed and the B color converting output is output from the third amplifier 101-3. At the same time, the unit pixel switches P6 and P9 and sixth and ninth switches S6 and S9 are closed to output the R and G color converting outputs from the first and second amplifiers 101-1 and 101-2.

In an embodiment of the inventive concept, as shown in FIG. 4, gamma voltages are separately generated according to R, G, and B colors by individual, e.g., separate, gamma voltage generators, and then applied to a corresponding drive circuit 100 in the data driver 6 to obtain first, second, and third color converting outputs via nodes ND1, ND2, and ND3 through at least three channels. The first, second, and third color converting outputs are alternately and sequentially applied to common pixel nodes of a panel. According to such a method for driving a data driver, since RC delay time is significantly reduced, gamma settling time is substantially minimized. In embodiments of the inventive concept, the meaning of the expression “alternately and sequentially” is that R, G, and B outputs are supplied for a first time period, G, B, and R outputs are supplied for a second time period, and B, R, and G outputs are supplied for a third time period. The first, second, and third time periods are periods that are mutually and sequentially set on the axis of time.

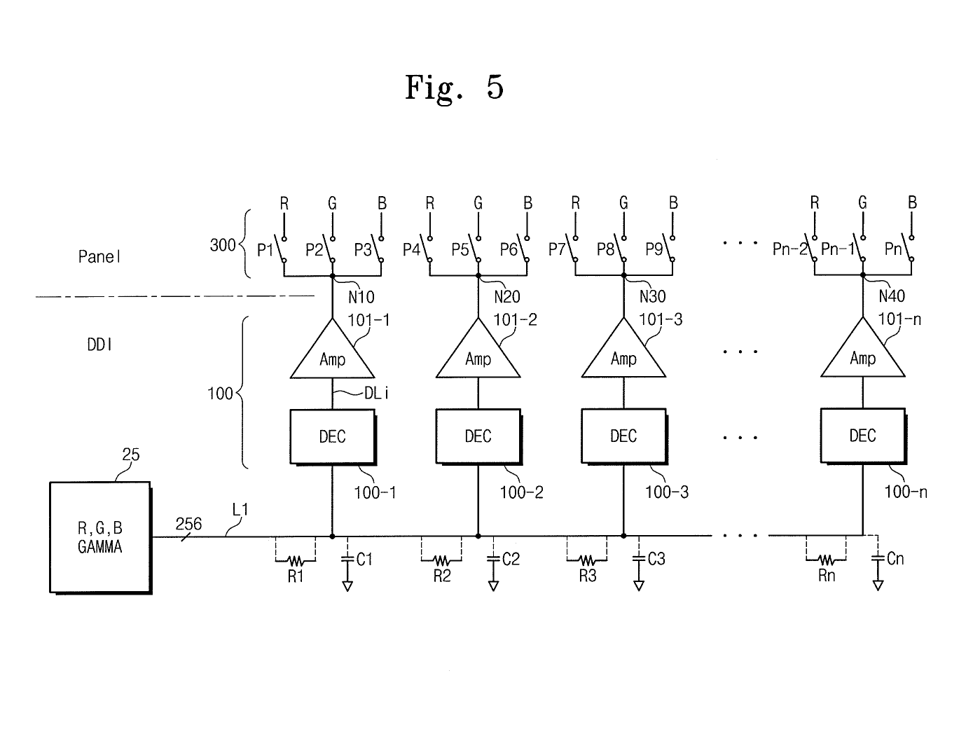

Parasitic resistors R1, R2, and R3 and parasitic capacitors C1, C2, and C3 viewed at lines L10, L20, and L30 in FIG. 4 have relatively smaller values than parasitic resistors R1, R2, R3, and Rn and parasitic capacitors C1, C2, C3, and Cn viewed at a single line L1 in FIG. 5 when they are compared in a manner of line-to-line comparison. As a result, RC delay time at a single line in FIG. 4 may be reduced.

FIG. 5 is an exemplary diagram of a comparative structure having an increased gamma settling time when a single gamma voltage generator is used. As illustrated in FIG. 5, when an R gamma voltage, a G gamma voltage, and a B gamma voltage are output from a single, integrated gamma voltage generator 25 through a single line L1, the switching unit 200 of FIG. 4 is not required. In other words, first, second, and third color converting outputs are output in a time sharing manner, e.g., sequentially, through one amplifier in a one-amplifier one-pixel structure. In the structure in FIG. 5, as described above, the RC delay time is relatively long. Therefore, the gamma settling time may increase.

On the other hand, according to an example embodiment illustrated in FIG. 4, although RC delay time is made longer when the number of channels increases, there is no voltage transaction between R, G, and B gamma voltages due to the separate voltage generators and lines. Thus, the gamma settling time issue caused by an increased RC delay disappears, i.e., the gamma settling time may not increase despite an increased number of channels. Moreover, the switching unit 200 according to example embodiments may be provided at the back end of the drive circuit 100 to sequentially output the R, G, and B through one channel in a time sharing manner in one-amplifier one-pixel structure.

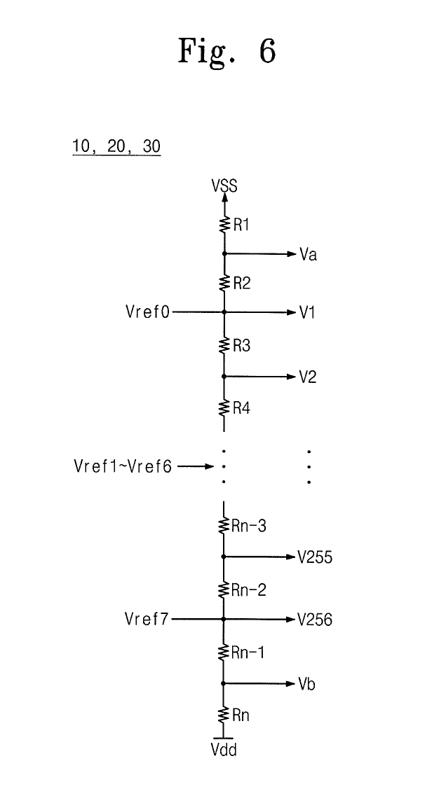

FIG. 6 is a circuit diagram illustrating a first implementation example of the gamma voltage generator in FIG. 3. As illustrated in FIG. 6, among gamma voltage generators 10, 20, and 30, the gamma voltage generator 10 includes a plurality of resistors R1-Rn coupled in series between a first supply voltage VSS and a second supply voltage VDD. The first supply voltage VSS has a lower level than the second supply voltage VDD. The gamma voltage generator 10 generates a first voltage Va at a voltage division node between the first and second resistors R1 and R2 connected in series to the first supply voltage VSS, and supplies the first voltage Va to the decoder 100-1. In addition, the gamma voltage generator 10 generates a second voltage Vb at a voltage division node between (N−1)th and Nth resistors Rn−1 and Rn connected in series to the second supply voltage VDD, and supplies the second voltage Vb to the decoder 100-1.

A minimum reference gamma voltage Vref0 is supplied to a voltage division node between second and third resistors R2 and R3, and a maximum reference gamma voltage Vref7 is supplied to a voltage division node between (N−2)th and (N−1)th resistors Rn−2 and Rn−1. In addition, reference gamma voltages Vref2˜Vref6 between the minimum and maximum reference gamma voltages Vref0 and Vref7 are supplied to specific voltage division nodes between fourth to (N−2)th resistors R4˜Rn−2, respectively. Accordingly, the gamma voltage generator 10 generates 256 gamma voltages V1-V256 at voltage division nodes between second and (N−1)th resistors R2 and Rn−1, and supplies the 256 gamma voltages V1-V256 to the decoder 100-1.

In case of FIG. 6, the R gamma voltage generator 10 has been representatively described. However, the G and B gamma voltage generators 20 and 30 have the same configuration as shown in FIG. 6, except that resistances are different.

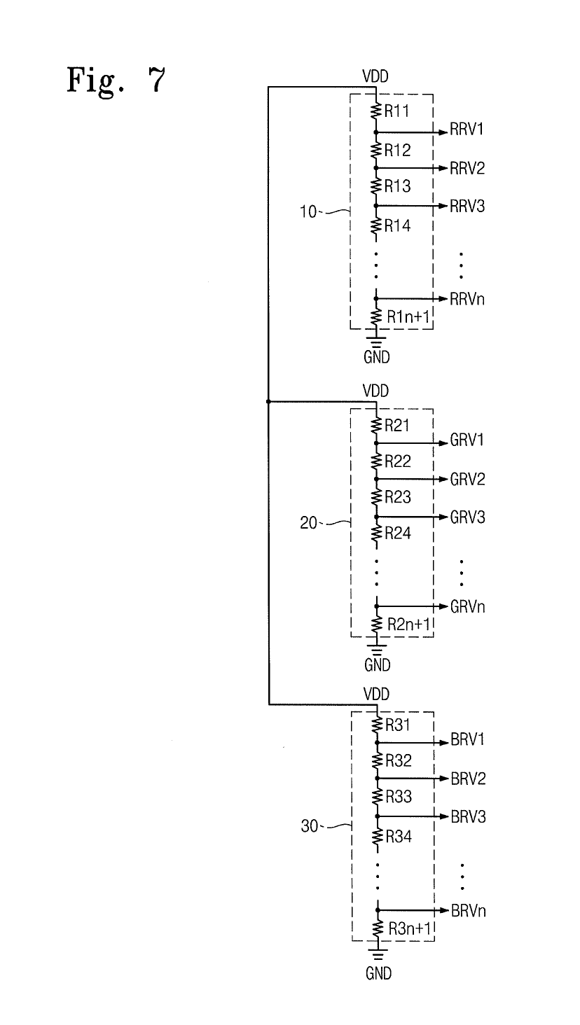

FIG. 7 is a circuit diagram illustrating a second implementation example of the gamma voltage generator in FIG. 3. In FIG. 7, configurations of the R gamma voltage generator 10, the G gamma voltage generator 20, and the B gamma voltage generator 30 commonly connected to a second supply voltage VDD are shown. In case of the R gamma voltage generator 10, a plurality of resistors R11, R12, R13, R14, and R1n+1 are coupled in series between the second supply voltage VDD and a first supply voltage GND.

FIG. 8 is an exemplary implementation diagram of the decoder 100-1 in FIG. 4. It is noted that only the structure of the decoder 100-1 is described for convenience, and the structures of the decoders 100-2 and 100-3 may be identical to that of the decoder 100-1. As illustrated in FIG. 8, the decoder 100-1 may include an 8-bit decoder 136 and a selective switching unit 138.

In detail, the 8-bit decoder 136 selects one of 256 gamma voltages V1-V256 according to respective bits D0-D7 of 8-bit modulation data, and outputs the selected gamma voltage through a common line 139. The selective switching unit 138 selects one of the first and second voltages Va and Vb according to a sine bit Sbit, and outputs the selected voltage through the common line 139.

The 8-bit decoder 136 includes first to eighth transistors coupled in series between the common line 139 and each respective input line of the 256 gamma voltages V1-V256 from the gamma voltage generator, e.g., from the R gamma voltage generator 10. Each of the first to eighth transistors is disposed as a combination of an N-type transistor and a P-type transistor to select any one of the 256 gamma voltages V1-V256 according to respective bits D0-D7 of the 8-bit modulation data MRGB.

A gate electrode of each first transistor is electrically connected to an 8-bit (MSB, D7) input line of the 8-bit modulation data MRGB, and a source electrode thereof is electrically connected to an input line of each of the gamma voltages V1-V256. In addition, a drain electrode of each first transistor is electrically connected to a source electrode of a second transistor. Gate electrodes of second to seventh transistors are connected to second to seventh bit (D1-D6) input lines of the 8-bit modulation data MRGB, respectively. Each source electrode is electrically connected to a drain electrode of a previous transistor. A drain electrode of each of the second to seventh transistors is electrically connected to a source electrode of the next transistor. A gate electrode of each eighth transistor is connected to a first bit (LSB, D0) input line of the 8-bit modulation data MRGB, and a source electrode thereof is electrically connected to a drain electrode of a previous transistor. In addition, a drain electrode of each eight transistor is electrically connected to a common line 139.

For example, when the modulation data MRGB supplied from the latch 122 (FIG. 2) is ‘11111111’, the 8-bit decoder 136 turns on eight N-type transistors connected in series to a 256th gamma voltage (V256) input line to select a 256th gamma voltage V256 among the 256 gamma voltages V1-V256 as an image signal, and supplies the selected 256th gamma voltage V256 to a data line DLi through the common line 139. In another example, when the modulation data MRGB supplied from the latch 122 is ‘00000000’, the 8-bit gamma decoder 136 turns on eight P-type transistors connected in series to a first gamma voltage (V1) input line to select a first gamma voltage V1 among the 256 gamma voltages V1-V256 as a pixel signal, and supplies the selected first gamma voltage V1 to the data line DLi through the common line 139. In conclusion, the 8-bit decoder 136 turns on eight transistors connected in series to the 256 gamma voltages (V1-V256) input lines according to the modulation data MRGB of ‘00000000’ to ‘11111111’ to select any one of the 256 gamma voltages V1-V256 as an image signal and supplies the selected gamma voltage to the data line DLi through the common line 139.

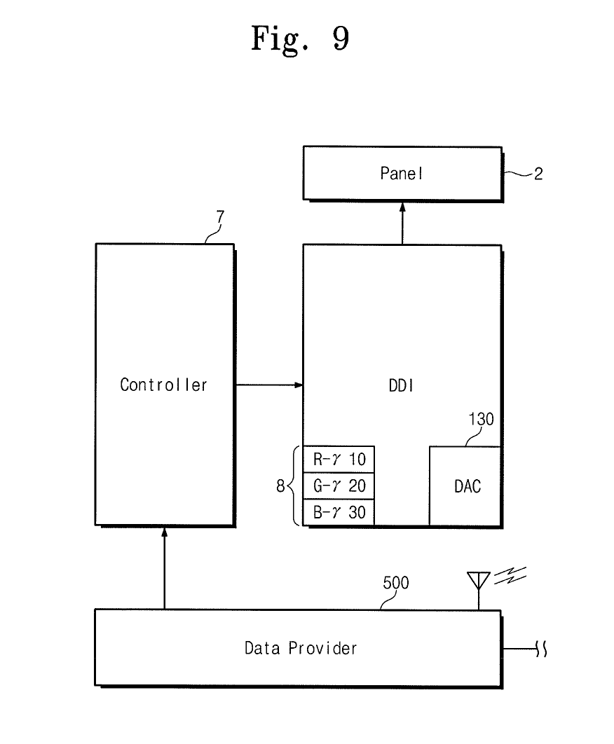

FIG. 9 is a block diagram of a mobile electronic device employing a DDI according to the inventive concept. As illustrated in FIG. 9, the mobile electronic device includes the panel 2, the data driver 6, a controller 7, and a data provider 500. The data driver 6 may be the DDI according to the inventive concept with the configuration of FIG. 3. Therefore, when the data provider 500 applies display data to be provided on the panel 2 to the controller 7, the DDI 6 performs a data driving operation at high speed due to relatively short gamma settling time. Accordingly, even when the panel 2 is a large-sized screen, a data driving operation is performed at high speed to prevent degradation of image quality.

The mobile electronic device may be connected to an external communication device through the data provider 500. The communication device may be, e.g., a digital versatile disc (DVD) player, a computer, a set top box (STB), a game player, a digital camcorder or the like. In the case that the data provider 500 includes a storage employed in a computer or the like, the storage stores data information having various types of data, e.g., texts, graphics, software codes, and so forth. The storage may be implemented in, e.g., an electrically erasable programmable read-only memory (EEPROM), a flash memory, a magnetic RAM (MRAM), a spin-transfer torque MRAM, a conductive bridging RAM (CBRAM), a ferroelectric RAM (FRAM), a phase change RAM (PRAM) referred to an ovonic unified memory (OUM), a resistive RAM (RRAM or ReRAM), a nanotube RRAM, a polymer RAM (PoRAM), a nano floating gate memory (NFGM), a holographic memory, a molecular electronics memory device, or an insulator resistance change memory.

Although not shown in the figure, it should be apparent to those skilled in the art that the mobile electronic device may further include, e.g., an application chipset, a camera image processor (CIS), a mobile dynamic random access memory (mobile DRAM), and so forth.

A memory constituting the data provider 500 or the controller 7 may be packaged as one of various types to be sequentially embedded. For example, a memory and/or a controller may be packaged by one of PoP (Package on Package), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), and Wafer-Level Processed Stack Package (WSP).

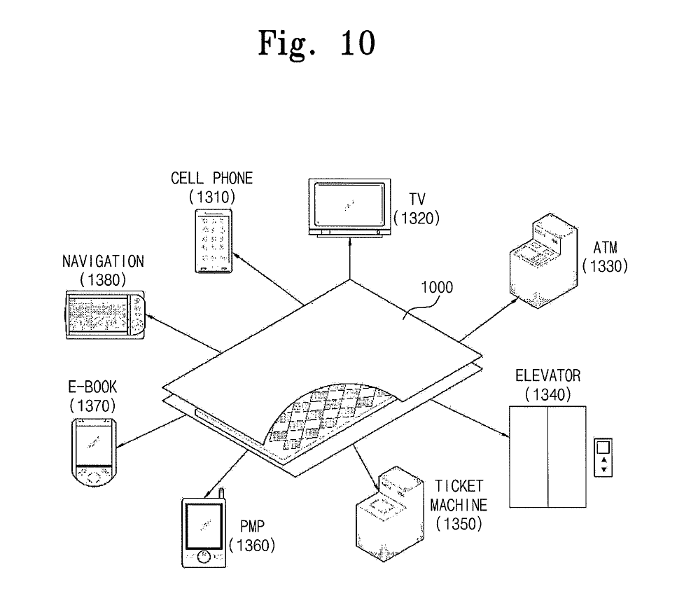

FIG. 10 is a block diagram illustrating an application example applied to various display devices. Referring to FIG. 10, a display device 1000 may include the DDI according to example embodiments. The display device 100 may be employed in a cellular phone 1310 or may be widely used in at least one of a liquid crystal display (LCD), a plasma display panel (PDP) television 1320, an automatic teller machine 1330 allowing customers to withdraw currency and make deposit, a ticket issuing machine 1350 used in subways or the like, a portable multimedia player (PMP) 1360, an e-book 1370, and a navigation system 1380. In all the fields requiring a user interface, the display device 1000 may mount a touch-screen system. Particularly, it may be efficient to mount such a touch-screen system on a cellular phone.

The display device 1000 may operate on a large-sized screen at higher speed because gamma settling time is short according to an embodiment of the inventive concept. Thus, performance of the display device 1000 is enhanced.

According to the above-described embodiments of the inventive concept, gamma settling time may be substantially reduced or minimized. Thus, driving speed of a display drive device may be improved.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A data driver driving method, comprising:
separately generating gamma voltages through respective separate gamma voltage generators according to colors;
applying the separate gamma voltages to their corresponding drive circuits in a data driver through separate channels to obtain first, second, and third color converting outputs; and
alternately and sequentially applying the first, second, and third color converting outputs to common pixel nodes of a panel.

2. The data driver driving method as claimed in claim 1, wherein generating the gamma voltages includes generating an R gamma voltage, a G gamma voltage, and a B gamma voltage having different voltage levels.

3. The data driver driving method as claimed in claim 2, wherein:
applying the separate gamma voltages to their corresponding drive circuits includes applying the R gamma voltage, the G gamma voltage, and the B gamma voltage to respective first, second, and third decoders; and
obtaining the first, second, and third color converting outputs includes obtaining outputs of respective first, second, and third amplifiers connected to respective output terminals of the first, second, and third decoders.

4. The data driver driving method as claimed in claim 3, wherein the first, second, and third color converting outputs are output simultaneously at the outputs of the respective first, second, and third amplifiers.

5. The data driver driving method as claimed in claim 1, wherein applying the generated voltages through separate channels includes using an R channel, a G channel, and a B channel in a one-amplifier one-pixel structure.

6. The data driver driving method as claimed in claim 1, wherein the panel is an organic light emitting diode (OLED) panel.

7. The data driver driving method as claimed in claim 1, wherein alternately and sequentially applying the color converting outputs includes applying the first, second, and third color converting outputs alternately in orders of first-second-third color converting outputs, second-third-first color converting outputs, and third-first-second color converting outputs when they are applied to adjacent first, second, and third common pixel nodes among the common pixel nodes.

8. The data driver driving method as claimed in claim 1, wherein alternately and sequentially applying the color converting outputs includes varying a color arrangement order of a unit pixel switch connected to the common pixel node in accordance with pixel locations in the panel.

9. The data driver driving method as claimed in claim 8, wherein varying the color arrangement includes disposing the unit pixel switch in an order of R, G, B, G, B, R, B, R, and G colors when first, second, and third pixels are disposed in the panel.

10. The data driver driving method as claimed in claim 9, wherein varying the color arrangement includes repeating the color arrangement order of the unit pixel switch in units of three pixels.

11. A display drive device, comprising:
first, second, and third gamma voltage generators configured to generate gamma voltages according to R, G, and B colors;
a drive circuit configured to receive the gamma voltages generated according to the R, G, and B colors through three channels, and to generate first, second, and third color converting outputs by adding the received gamma voltages to a pixel signal according to the channels; and
a switching unit configured to alternately and sequentially apply the first, second, and third color converting outputs to common pixel nodes of a panel.

12. The display drive device as claimed in claim 11, wherein the three channels are an R channel, a G channel, and a B channel in a one-amplifier one-pixel structure.

13. The display drive device as claimed in claim 11, wherein the drive circuit includes:
first, second, and third decoders configured to receive the R gamma voltage, the G gamma voltage, and the B gamma voltage, respectively; and
first, second, and third amplifiers connected to output terminals of the first, second, and third decoders, respectively.

14. The display drive device as claimed in claim 13, wherein the panel is a liquid crystal panel or an active organic light emitting diode panel.

15. The display drive device as claimed in claim 11, wherein a color arrangement order of a unit pixel switch connected to the common pixel node varies in accordance with pixel locations in a panel.

16. The display drive device as claimed in claim 15, wherein the unit pixel switch is repeatedly disposed in every three pixels in the order of R, G, B, G, B, R, B, R, and G colors.

17. A display drive device, comprising:
a plurality of separate gamma voltage generators configured to generate respective separate gamma voltages according to colors;
a drive circuit configured to receive the separate gamma voltages and to generate respective color converting outputs; and
a switching unit configured to alternately and sequentially apply the color converting outputs to common pixel nodes of a panel.

18. The display drive device as claimed in claim 17, further comprising a plurality of separate channels connected to the gamma voltage generators, respectively, the separate gamma voltages being transmitted to the drive circuit independently of each other.

19. The display drive device as claimed in claim 18, wherein the display drive device includes three separate gamma voltage generators, the gamma voltage generators being configured to generate gamma voltage according to R, G, or B colors, respectively.

20. The data driver driving method as claimed in claim 17, wherein the drive circuit is configured to output the respective color converting outputs simultaneously.
